(19) United States
(12) Patent Application Publication
(10) Pub. No.: US 2008/0229254 A1
(43) Pub. Date: Sep. 18, 2008

(54) METHOD AND SYSTEM FOR ENHANCED CURSOR CONTROL

(76) Inventor: ERVIN-DAWSON WARNER, CHICAGO, IL (US)

Correspondence Address: JUNEAU PARTNERS, P.O. BOX 2516, ALEXANDRIA, VA, 22301, US

(21) Appl. No.: 11/690,801

(22) Filed: Mar. 23, 2007

Related U.S. Application Data
(60) Provisional application No. 60/785,272, filed on Mar. 24, 2006.
(60) Provisional application No. 60/789,916, filed on Apr. 7, 2006.

(51) Int. Cl. G06F 3/048

(52) U.S. Cl. 715/856

(57) ABSTRACT

Methods and systems for moving a cursor quickly, efficiently, and accurately on displays with increasingly higher resolutions, for moving a cursor when the motion and range of the input device (mouse, keyboard, joystick, trackpad™, trackpoint™, etc.) is constrained, and for avoiding the problem of large repetitive motions when using an input device to move the cursor on computer displays.

### PRIORITY CLAIM

This application claims benefit under 35 USC 119(e) of the filing date of U.S. provisional No. 60/785,272 filed 24 Mar. 2006 and also of U.S. provisional No. 60/789,916 filed 7 Apr. 2006.

### BACKGROUND

1. Field of the Invention

The invention relates to computer hardware and associated software, and in particular, a standard computer peripheral, e.g. a mouse, for controlling the cursor, and predictive software that improves functionality.

2. Description of the Prior Art

Currently, there are various problems associated with moving a cursor on a computer screen using a mouse or other similar peripheral device. There is a problem of moving a cursor quickly, efficiently, and accurately on displays with increasingly higher resolutions. There is also a problem of moving a cursor when the motion and range of the input device (mouse, keyboard, joystick, trackpad™, trackpoint™, etc.) is constrained. Finally, there is the problem of large repetitive motions when using a input device to move the cursor on computer displays which can cause discomfort and injury.

Various U.S. patents are described herein to show the state of the art in this field.

U.S. Pat. No. 5,598,183 discloses a system determining an intended cursor location on the computer display screen and automatically repositions the cursor at the intended location. If the user selects a command that alters the contents of the display, such as opening a new window, the system analyzes the new screen display to determine whether there are user selectable options associated with the new screen display. The system determines if one of the user selectable options is a default option and automatically positions the cursor at the default option. If the new screen display is an application program, the system attempts to locate a user selectable option and repositions the cursor at the user selectable option. When the new window is closed, the system returns the cursor to the position it was at before the new window was opened. The system also predicts an intended location for a screen display that has not been altered, and automatically positions the cursor at the intended location. This feature can be selectively enabled to prevent the inadvertent repositioning of the cursor in the display.

U.S. Pat. No. 5,298,890 discloses a cursor moving system includes a designated-area management unit for processing for display on a screen of areas to be designated by a cursor. A cursor position management unit processes movement of a cursor indication position on the screen according to a cursor moving operation by a pointing device. A cursor position determination unit searches for a designated area to which the cursor belongs now, and another designated area existing in a travelling direction of the cursor, based on information on a current position of the cursor and information on a travelling direction of the cursor received from the cursor position management unit in response to the pointing device. It also determines whether or not the nearest designated area existing in a travelling direction is separated from the current designated area. If separated, then it informs the cursor position management unit, when the cursor arrives at the boundary of the current designated area, of position information on a cursor display position, which resides within the determined nearest other designated area and is nearest from the designated area in which the cursor resides now, as the current position information of the cursor at that time. The cursor position management unit recognizes the position information communicated from the cursor position determination unit as information of the current position, and thereafter sequentially modifies such a newly recognized current position information based on the travelling direction and amount information from the pointing device, so that the cursor is sequentially moved.

U.S. Pat. No. 4,987,411 discloses a pointing apparatus includes a direction determination circuit for determining a moving direction of a cursor in accordance with cursor current position information and cursor moving information input from a mouth, and a cursor jump circuit for recognizing the presence/absence of an icon to be designated by the cursor near a position along the moving direction determined by the direction determination circuit, and for jumping the cursor to the position of the icon.

U.S. Pat. No. 5,195,179 discloses a coordinate input apparatus responsive to physical movement of an operation section for moving and displaying a cursor displayed on a display screen at a corresponding coordinate position on the display screen has a unit for deciding a ratio of cursor movement which detects the operation speed of the operation section and decides the ratio of cursor movement on the display screen for a predetermined amount of the movement of the operation section based on the operation speed. A display unit moves and displays the cursor on the display screen corresponding to the amount of movement of the operation section based on the ratio of cursor movement thus decided. As a result, even if the amount of movement of the operation section is constant, when the operation section is moved at a high speed, the cursor moves a long distance; whereas, when the operation section is moved at a low speed, the cursor moves a short distance.

U.S. Pat. No. 6,031,531 discloses a method and system for assisting physically challenged users in positioning cursor objects at desired icons displayed within a graphic interface of a computer system. Icons are displayed within the graphic interface, such that an icon, when graphically selected by a user, facilitates a particular application function. Icon domains are established about each icon, wherein each icon domain is larger than the icon itself. The cursor object may thereafter be automatically positioned at the center of a particular icon, in response to moving the cursor object into an icon domain associated with that particular icon, thereby assisting physically challenged users in efficiently positioning the cursor object at the icon in order to graphically select a particular function associated with the icon. According to this method and system, the icons are thereby graphically magnetized, such that a cursor object is immediately snapped toward a desired icon when entering a graphically magnetized domain surrounding the desired icon, eliminating the need for positioning the cursor object precisely on the icon or other graphical object to be selected.

U.S. Pat. No. 6,995,746 discloses a method of processing the movement of a cursor over a screen (12) which comprises one or more cursor activatable zones (10), at least one activatable zone (10) being surrounded by an attraction zone (11) which is associated therewith, and the method carrying out, during the movement of the cursor, toward a specified position (2) which is actual or fictitious, a conditional attraction step automatically placing the cursor on a specified activatable zone (10) only if a first condition is fulfilled, the first condition being fulfilled if the specified position is situated in the attraction zone (11) associated with the specified activatable zone (10). The invention can in particular be applied to an aircraft console screen.

U.S. Pat. No. 5,870,079 discloses a computer input device, such as a mouse, and a method of operating the same. Initially, the location of the cursor at various times on the screen is detected. From these various positions a path of travel and a rate of travel of the cursor are computed. Display objects, such as buttons, which exist along or near the path of travel are identified and designated as potential targets. The rate of change in the rate of travel is also computed. This information is used to decide if a user is slowing down in approach of a specific screen display object. If certain deceleration criteria are met, then that target which the user is approaching is designated as the intended target and the cursor is translated smoothly to that target. After the pointer has been moved to the intended display object, the pointer is maintained at that object and small mouse movements are ignored, thereby allowing the user to maintain the cursor on the desired target despite small, possibly inadvertent, mouse movements. If the movement or acceleration of the mouse exceed a predetermined threshold, then this hold is released.

U.S. Pat. No. 5,596,347 discloses a system determining an intended cursor location on the computer display screen and automatically repositions the cursor at the intended location. If the user selects a command that alters the contents of the display, such as opening a new window, the system analyzes the new screen display to determine whether there are user selectable options associated with the new screen display. The system determines if one of the user selectable options is a default option and automatically positions the cursor at the default option. If the new screen display is an application program, the system attempts to locate a user selectable option and repositions the cursor at the user selectable option. When the new window is closed, the system returns the cursor to the position it was at before the new window was opened. The system also predicts an intended location for a screen display that has not been altered, and automatically positions the cursor at the intended location. This feature can be selectively enabled to prevent the inadvertent repositioning of the cursor in the display.

U.S. Pat. No. 4,698,625 discloses a technique is disclosed which facilitates the selection by a user of a graphic object on a display screen. Selection is by means of a pointing cursor which is moved about the display screen by means of a pointing device having a select button. When the pointing cursor is brought within a predetermined distance of a graphic object, the point on the graphic object closest to the pointing cursor is highlighted to show the user that that graphic object would be selected if the select button were pressed. If the user presses the select button when a point on a graphic object is highlighted, the entire graphic object is highlighted to indicate that it has been selected.

U.S. Pat. No. 5,198,802 discloses a system of using both a mouse (13) and a keyboard (21) for entry of function selection by cursor (17) is achieved by the system recognizing a mouse entry as such and not moving cursor (17) with transition of displays, while keyboard operation moves the cursor in increments and repositions the cursor as appropriate on transition of displays. Further, after a screen transition the cursor is moved to the normal initial cursor location of the new screen when a keyboard operation calls for cursor movement while the cursor is not near a selection symbol.

U.S. Pat. No. 5,230,063 discloses an object-oriented graphic interface for use in computer controlled display systems. A central processing unit (CPU) is provided and is coupled to a display for displaying graphic and other data. The CPU is further coupled to a cursor control device which permits a user to selectively position a cursor at a desired location on the display, and signal the CPU of selections in accordance with the teachings of the present invention. Buttons are generated by the CPU and displayed which correspond to either a single function to be executed by the CPU, or a button stack which has associated therewith a plurality of functions disposed on a menu. The menu includes a plurality of buttons and/or button stacks. The menu also includes a first icon, which presently is in the form of a push pin. The placement of the cursor over the push pin and releasing the first switch on the cursor control results in the CPU converting the menu into a window. The CPU then retains this window on the display regardless of other display operations performed. The window may be dismissed, at any time, by placing the cursor over a push pin provided on the border of the window and momentarily depressing and releasing the first switch on the cursor control device. In addition, if the user once again places the cursor over the push pin and momentarily depresses and releases the first switch on the cursor control device, then the window will be dismissed after the execution of any of the button or button stacks disposed within the window.

U.S. Pat. No. 5,283,562 discloses a map display apparatus for displaying a wide area map and an enlarged map is disclosed. When a display mode is shifted from the mode of displaying the enlarged map to the mode of displaying the wide area map, a cursor frame is displayed on a position on a parent screen corresponding to the divided area which has been displayed in an enlarged manner just before the shift of the display mode, so that the position on the parent screen of the area which has been displayed in the enlarged manner so far can be easily discriminated.

U.S. Pat. No. 6,86,790 discloses methods and apparatus are provided for controlling pointer movement on a user interface display screen in a computer system. Selected areas of a display screen are defined to provide predetermined pointer movement control actions. Visual cues to the selected areas are provided for the user. In accordance with a feature of the invention, the pointer movement control actions assist computer users in selecting desired operations or objects while minimizing potential for inadvertent user selections or mistakes.

U.S. Pat. No. 6,219,028 discloses methods and apparatus implementing a technique for displaying content on a display device of a computer system and removing a cursor so it does not obscure the content as it is being displayed. In general, in one aspect, the technique includes identifying a cursor region occupied by the cursor on a display device screen, detecting collisions between new content and the cursor region, and removing the cursor from its position on the screen in response to collisions. As a result, the cursor does not obscure the new content on the screen.

U.S. Pat. No. 6,229,518 discloses apparatus and methods perform an improved cursor controlling technique by determining a spatial relationship between a graphics element and a cursor, and then writing the graphics element without turning off the cursor if the graphics element and the cursor do not overlap.

U.S. Pat. No. 6,747,681 discloses smoother transitions between changing cursor images which are less stressful to the interactive user of a computer controlled display are provided by apparatus for changing the cursor image, including a frame buffer for storing the display screen image as a pixel array, a separate display buffer for storing the current cursor image as a pixel array, together with apparatus for storing an alternate cursor image as a pixel array during the display of the current cursor image, and means for replacing the current cursor image with the alternate cursor image. In raster scan apparatus for maintaining screen images in the frame buffer on said display screen, there are means for effecting the replacement of said cursor images during a vertical blanking period in said raster scanning.

U.S. Pat. No. 6,788,284 discloses devices, systems and methods for position-locking a cursor on a display device are provided. A preferred input device includes a position-locking device configured to electrically communicate with a computer. The position-locking device incorporates a lock-enable switch which, when activated, locks a position of the cursor on the display device of the computer while enabling functional information, provided by the mouse-type input device of the computer, to provide selected functionality of the cursor. Additionally, when disabled, the position-locking device unlocks the position of the cursor so that the cursor is movable about the display area in response to the movement information provided by the mouse-type device.

U.S. Pat. No. 6,677,930 discloses a mouse for a computer has a small touch panel to realize improved functions. The mouse (40) has a lower case (41) and an upper case (42) that covers an upper part of the lower case. A front part of the upper case has an integrated support. The touch panel is installed on the support, and a key top (43) is fitted to the upper case to fix the touch panel. An instruction is generated according to a finger touching period or the movement of a finger on the touch panel, and the instruction is transmitted to the computer, to thereby realize the improved functions. The touch panel may be divided into sections, and some of the sections may be used as switches, to thereby eliminate click switches from the mouse.

U.S. Pat. No. 5,808,601 discloses an analog to a gravitation force field is generated mathematically to operate between the displayed image of the mouse selection pointer on the screen of a computer display as it interacts with defined selectable objects on the screen. Unlike true gravity, however, the force may be mathematically defined as positive or negative and, thus, permits both attractive and repulsive effects to be imposed upon the movement of the mouse selection pointer displayed on the screen. The paradigm of interaction between the mouse selection pointer displayed on the screen and objects which are selectable thereon is changed to include effects of “mass” as represented by an effective field of force operating between the mouse selection pointer display and various selectable items on the screen. Mathematical calculation for the effective radius, or boundary, at which the force calculated to exist between a mouse selection pointer with an assigned mathematical value for mass and an object having an assigned mathematical value for mass may be easily implemented. When the displayed mouse selection pointer position on the screen comes within the force boundary of an object at which the calculated force is at least equal to the mass assigned to the mouse selection pointer attraction instantaneous capture of the mouse selection pointer to the object whose force boundary has been crossed can be achieved. Similarly, though inverse, repulsion between the mouse selection pointer and objects which are deemed unselectable by a computer application running in a computer system may also be implemented.

U.S. Pat. No. 5,703,620 discloses that the movement of a manual input device in an information processing system determines the movement of a cursor across the system's display. The display visualizes a virtual space, e.g., in a multi-media environment. Certain stationary or moving areas on the display represent target areas serving as possible destinations for the cursor. In order to create a catching effect on the cursor, the system requires more user movement to leave than to enter the target region, thus enhancing target acquisition performance of the user.

### SUMMARY

The invention—“software” or “Zippy Mouse” or “EnhancaCursor”—displays one or more “virtual cursors”, one or more images indicative of a point on a computer display, at calculated intended cursor destinations*, points on a computer display where the user may intend to position the cursor. In other words, the software guesses the intended cursor destination and then places several virtual cursors at the calculated destination and at several relevant nearby positions. The user can then select the virtual cursor that is at or closest to their intended location via an input device (eg. mouse click, key press, button push, etc.) After the user selects the closest virtual cursor via an input device, the software then repositions the cursor to the position of the selected virtual cursor. The virtual cursor may or may not be hidden at this point. Then the user, utilizing the normal cursor control procedures, can reposition the cursor to the final intended position and select the desired object, a procedure that is now significantly shorter and faster because the invention has moved the cursor significantly closer to the user's intended cursor destination. Alternatively, after a virtual cursor is selected by the user, the software can be set to repeat a sequence of stored user input actions (key presses, mouse clicks, button presses, etc.) after repositioning the cursor at the calculated intended cursor destination. This option significantly reduces the manual process of repositioning the cursor and eliminates the possibility of requiring a redundant user-input action. Finally, after repositioning the cursor at the calculated intended cursor destination, the software allows the user to quickly return to the prior cursor position by selecting a new virtual cursor that is, optionally, displayed at the prior cursor position. This option allows the user to quickly move back and forth between two distant positions on the computer display.

It should be noted that the primary methods of the software are not limited to using any system information pertaining to the location or position of existing objects (windows, images, etc.) or user-selectable controls (icons, drop-downs, etc.) on the display. Information used to determine the intended cursor destination can also include a consolidated analysis of individually read cursor positions, previously stored cursor positions, and in many instances the characteristics and identifiers of objects that where previously manipulated (e.g. clicked, highlighted, selected, etc). In addition, information pertaining to objects (e.g. location, characteristics, identifiers, etc.) that can be selected by the user can be passed into the invention via user client applications and software application interfaces that connect with the invention.

In preferred embodiments, methods, systems, and computer readable media are provided for practicing the invention.

In one embodiment, a method of drawing a virtual screen on a computer display is provided, comprising the steps of: determining movement of cursor on a computer display coupled to a computer in accordance with manipulations of a pointing device, including recognizing a start cursor position on the screen, a current cursor position on the screen, and a stop cursor position on the screen; drawing a virtual screen, a visible area on the computer display that maps to positions on the computer display, behind the start cursor position, current cursor position, or stop cursor position.

In another preferred embodiment, a method of interpolating the future cursor path on a computer display is provided, comprising the steps of: determining movement of a cursor on a computer display coupled to a computer in accordance with manipulations of a “pointing device” (mouse, keyboard, joystick, trackpad, trackpoint, etc.), including recognizing a start cursor position on the screen and a current cursor position on the computer display; storing the movement of a cursor from the recognized start cursor position to the current cursor position on a computer display in a storage area; calculating a path representing the movement of a cursor on a computer display from the start point to the current position; interpolating the future path of the cursor from the current position based on the calculated path representing the movement of a cursor on a computer display from the start point to the current position.

Optionally, this embodiment may also include the step of: identifying one or more points on or near the interpolated cursor path as an intended cursor destination.

In yet another preferred embodiment, a method of interpolating the future cursor path on a computer display is provided, comprising the steps of: determining movement of a cursor on a computer display coupled to a computer in accordance with manipulations of a pointing device, including recognizing a start cursor position on the screen and a final cursor position on the computer display; storing the start cursor position and the final cursor position on a computer display in a storage area; calculating a path representing the movement of a cursor on a computer display from the start cursor position to the final cursor position; interpolating the future path of the cursor from the current position based on the calculated path representing the movement of a cursor on a computer display from the start cursor point to the final cursor position.

Optionally, this embodiment may include the step of identifying one or more points on or near the interpolated future cursor path as an intended cursor destination.

In a further embodiment, a method of storing cursor action history and calculating areas of user interest based on the stored cursor action history is provided, comprising the steps of: determining movement of a cursor on a computer display coupled to computer in accordance with manipulations of a pointing device, including recognizing a start cursor position on the screen, a current cursor position, and a final cursor position on the computer display; determining a cursor action, a manipulations of an user input device at the final cursor position, including identifying a button presses and, if available, identifying information for the object to which the cursor action was dedicated; storing the cursor action history, the final cursor position on a computer display, the corresponding cursor action, and the identifying information for which the cursor action was dedicated; calculating areas of user interest, confined areas on the screen that contain more than a definable number of stored final cursor positions with corresponding cursor actions, based on the stored cursor action history.

This embodiment may optionally include the step of selecting one or more points within the calculated area of user interest as an intended cursor destination.

In yet a further preferred embodiment, a method of displaying a virtual cursor on a computer display is provided, comprising the steps of: determining movement of a cursor on a computer display coupled to a computer in accordance with manipulations of a pointing device, including recognizing movement, position, and actions of the cursor; displaying “virtual cursors”, one or more images indicative of a point on the screen, on a computer display in addition to the cursor(s) on a computer display coupled to a computer manipulated in accordance with manipulations of a pointing device.

This embodiment may also include the step of: positioning virtual cursors on a computer display at one or more calculated intended cursor destinations.

Another step may also be the step of: moving a virtual cursor on a computer display to a calculated intended cursor destination.

Yet a further step of this embodiment contemplates, the steps of: detecting the cursor action that indicates the computer user wants to move the cursor to the position of the virtual cursor; and moving the cursor to the position of the virtual cursor.

Additionally, the step of: simulating a cursor action at the position of the virtual cursor is provided.

The step of: detecting the cursor action that indicates the computer user wants to move the cursor to the position of the virtual cursor; and moving the cursor to the position of the virtual cursor are also included.

Another included step is the step of: simulating a cursor action at the position of the virtual cursor.

A further step in the method of moving the cursor to a calculated intended cursor destination, comprises the steps of: detecting the cursor action that indicates the computer user wants to move the cursor to the position of a calculated intended cursor destination; moving the cursor to the calculated intended cursor destination.

Another embodiment includes a method of inputting cursor action history into the invention from a source other than a computer coupled pointing device and calculating areas of user interest based on the inputted cursor action history, and comprises the steps of: inputting cursor action history into the invention from a source other a computer coupled pointing device; storing the inputted cursor action history, the final cursor position on a computer display, the corresponding cursor action, and the identifying information for which the cursor action was dedicated; calculating areas of user interest, confined areas on the screen that contain more than a definable number of stored final cursor positions with corresponding cursor actions, based on the inputted and stored cursor action history.

This embodiment may further include the step of: selecting one or more points within the calculated area of user interest as an intended cursor destination.

Also provided is a method of enhancing the visibility of the cursor on a computer display, comprising the steps of: determining movement of cursor on a computer display coupled to a computer in accordance with manipulations of a pointing device, including recognizing a start cursor position on the screen, a current cursor position on the screen, and a final cursor position on the screen; displaying at the start cursor position, current cursor position, or stop cursor position an object behind the cursor that is indicative of the same point on the screen the cursor indicates and that is more visible (larger, bolder, brighter, etc.) than the existing cursor.

Yet further preferred embodiments include systems for drawing a virtual screen on a computer display, which comprise: means for determining movement of cursor on a computer display coupled to a computer in accordance with manipulations of a pointing device, including recognizing a start cursor position on the screen, a current cursor position on the screen, and a stop cursor position on the screen; and, means for drawing a virtual screen, a visible area on the computer display that maps to positions on the computer display, behind the start cursor position, current cursor position, or stop cursor position.

A system for interpolating the future cursor path on a computer display is provided, which comprises: means for determining movement of a cursor on a computer display coupled to a computer in accordance with manipulations of a “pointing device” (mouse, keyboard, joystick, trackpad, trackpoint, etc.), including recognizing a start cursor position on the screen and a current cursor position on the computer display; means for storing the movement of a cursor from the recognized start cursor position to the current cursor position on a computer display in a storage area; means for calculating a path representing the movement of a cursor on a computer display from the start point to the current position; and, means for interpolating the future path of the cursor from the current position based on the calculated path representing the movement of a cursor on a computer display from the start point to the current position.

Yet another preferred system feature further comprises: means for identifying one or more points on or near the interpolated cursor path as an intended cursor destination.

Further provided is a system for interpolating the future cursor path on a computer display, which comprises: means for determining movement of a cursor on a computer display coupled to a computer in accordance with manipulations of a pointing device, including recognizing a start cursor position on the screen and a final cursor position on the computer display; means for storing the start cursor position and the final cursor position on a computer display in a storage area; means for calculating a path representing the movement of a cursor on a computer display from the start cursor position to the final cursor position; and, means for interpolating the future path of the cursor from the current position based on the calculated path representing the movement of a cursor on a computer display from the start cursor point to the final cursor position.

This system may also include means for identifying one or more points on or near the interpolated future cursor path as an intended cursor destination.

A system for storing cursor action history and calculating areas of user interest based on the stored cursor action history is provided, which comprises: means for determining movement of a cursor on a computer display coupled to computer in accordance with manipulations of a pointing device, including recognizing a start cursor position on the screen, a current cursor position, and a final cursor position on the computer display; means for determining a cursor action, a manipulations of an user input device at the final cursor position, including identifying a button presses and, if available, identifying information for the object to which the cursor action was dedicated; means for storing the cursor action history, the final cursor position on a computer display, the corresponding cursor action, and the identifying information for which the cursor action was dedicated; and, means for calculating areas of user interest, confined areas on the screen that contain more than a definable number of stored final cursor positions with corresponding cursor actions, based on the stored cursor action history.

This system may also include means for selecting one or more points within the calculated area of user interest as an intended cursor destination.

In yet a further preferred embodiment, a system for displaying a virtual cursor on a computer display is provided, which comprises: means for determining movement of a cursor on a computer display coupled to a computer in accordance with manipulations of a pointing device, including recognizing movement, position, and actions of the cursor; and, means for displaying “virtual cursors”, one or more images indicative of a point on the screen, on a computer display in addition to the cursor(s) on a computer display coupled to a computer manipulated in accordance with manipulations of a pointing device.

This system may include means for positioning virtual cursors on a computer display at one or more calculated intended cursor destinations.

Alternatively, it may include means for moving a virtual cursor on a computer display to a calculated intended cursor destination.

Further it may include means for detecting the cursor action that indicates the computer user wants to move the cursor to the position of the virtual cursor; and, means for moving the cursor to the position of the virtual cursor.

This system may further comprise: means for simulating a cursor action at the position of the virtual cursor.

This system may also further comprise: means for detecting the cursor action that indicates the computer user wants to move the cursor to the position of the virtual cursor; and, means for moving the cursor to the position of the virtual cursor.

And provided is a system further comprising: means for simulating a cursor action at the position of the virtual cursor.

A system for moving the cursor to a calculated intended cursor destination is preferably provided, which comprises: means for detecting the cursor action that indicates the computer user wants to move the cursor to the position of a calculated intended cursor destination; and, means for moving the cursor to the calculated intended cursor destination.

A system is provided for inputting cursor action history into the invention from a source other than a computer coupled pointing device and calculating areas of user interest based on the inputted cursor action history, which comprises: means for inputting cursor action history into the invention from a source other a computer coupled pointing device; means for storing the inputted cursor action history, the final cursor position on a computer display, the corresponding cursor action, and the identifying information for which the cursor action was dedicated; and, means for calculating areas of user interest, confined areas on the screen that contain more than a definable number of stored final cursor positions with corresponding cursor actions, based on the inputted and stored cursor action history.

This system may also include means for selecting one or more points within the calculated area of user interest as an intended cursor destination.

A system for enhancing the visibility of the cursor on a computer display is provided, which comprises: means for determining movement of cursor on a computer display coupled to a computer in accordance with manipulations of a pointing device, including recognizing a start cursor position on the screen, a current cursor position on the screen, and a final cursor position on the screen; and, means for displaying at the start cursor position, current cursor position, or stop cursor position an object behind the cursor that is indicative of the same point on the screen the cursor indicates and that is more visible (larger, bolder, brighter, etc.) than the existing cursor.

The present inventive subject matter preferably includes computer readable media containing software program code for carrying out the methods disclosed herein.

### BRIEF DESCRIPTION OF THE FIGURES

FIG. 1 is a flow chart showing the main software loop.

FIG. 2 is a flow chart and shows calculating the intended cursor destination using simple path of the cursor Method.

FIG. 3 is a flow chart and shows calculating the intended cursor destination using complex path of the cursor method.

FIG. 4 is a flow chart and shows calculating the intended cursor destination using the relative position in virtual screen.

FIG. 5 is a flow chart and shows enhancing the accuracy of the virtual cursors by using Smart Points.

FIG. 6 is a flow chart and shows using the scroll wheel to select one of many Virtual Cursors.

FIG. 7 is a flow chart and shows enhancing the accuracy of the virtual cursors by using an analysis of user-configurable objects.

FIG. 8 is a diagram and shows using the Simple Path method to get to a destination faster.

FIG. 9 is a diagram and shows using the Complex Path method to get to a destination faster.

FIG. 10 is a diagram and shows using the Virtual Screen method to get to a destination faster.

FIG. 11 is a diagram and shows selecting one of many virtual cursors.

FIG. 12 is a diagram and shows Smart Points—Map.

FIG. 13 is a diagram and shows Smart Objects—Map.

FIG. 14 is a screen shot and shows the EnhancaCursor Main Dialog.

FIG. 15 is a screen shot and shows the EnhancaCursor About Dialog.

FIG. 16 is a screen shot and shows the EnhancaCursor Registration Dialog.

FIG. 17 is a screen shot and shows the EnhancaCursor Configuration Dialog—General Settings

FIG. 18 is a screen shot and shows the EnhancaCursor Configuration Dialog—Advanced Settings.

FIG. 19 is a screen shot and shows the EnhancaCursor Configuration Dialog—Professional Settings.

### DETAILED DESCRIPTION OF THE PREFERRED EMBODIMENTS

### Definitions

The invention—“software” or “Zippy Mouse” or “EnhancaCursor”—displays one or more “virtual cursors”, one or more images indicative of a point on a computer display, at calculated intended cursor destinations*, points on a computer display where the user may intend to position the cursor. In other words, the software guesses the intended cursor destination and then places several virtual cursors at the calculated destination and at several relevant nearby positions. The user can then select the virtual cursor that is at or closest to their intended location via an input device (eg. mouse click, key press, button push, etc.) After the user selects the closest virtual cursor via an input device, the software then repositions the cursor to the position of the selected virtual cursor. The virtual cursor may or may not be hidden at this point. Then the user, utilizing the normal cursor control procedures, can reposition the cursor to the final intended position and select the desired object, a procedure that is now significantly shorter and faster because the invention has moved the cursor significantly closer to the user's intended cursor destination. Alternatively, after a virtual cursor is selected by the user, the software can be set to repeat a sequence of stored user input actions (key presses, mouse clicks, button presses, etc.) after repositioning the cursor at the calculated intended cursor destination. This option significantly reduces the manual process of repositioning the cursor and eliminates the possibility of requiring a redundant user-input action. Finally, after repositioning the cursor at the calculated intended cursor destination, the software allows the user to quickly return to the prior cursor position by selecting a new virtual cursor that is, optionally, displayed at the prior cursor position. This option allows the user to quickly move back and forth between two distant positions on the computer display.

It should be noted that the primary methods of the software are not limited to using any system information pertaining to the location or position of existing objects (windows, images, etc.) or user-selectable controls (icons, drop-downs, etc.) on the display. Information used to determine the intended cursor destination can also include a consolidated analysis of individually read cursor positions, previously stored cursor positions, and in many instances the characteristics and identifiers of objects that where previously manipulated (e.g. clicked, highlighted, selected, etc). In addition, information pertaining to objects (e.g. location, characteristics, identifiers, etc.) that can be selected by the user can be passed into the invention via user client applications and software application interfaces that connect with the invention.

*Calculating Intended Cursor Destinations—The software calculates the intended cursor destinations based on various criteria including but not limited to:

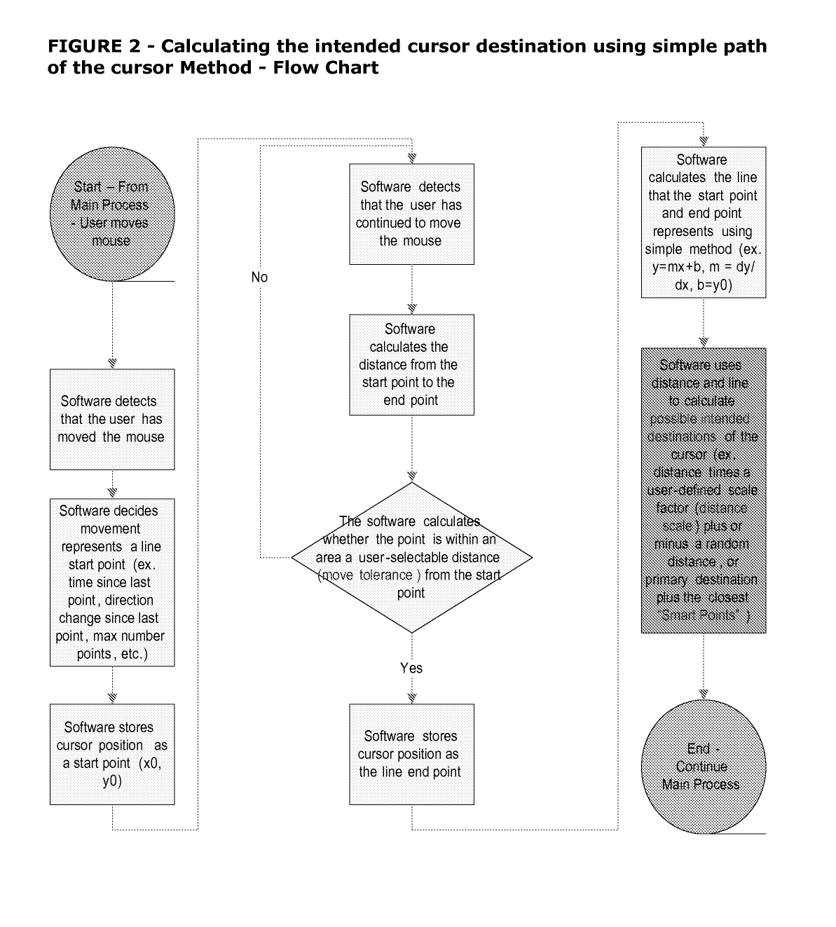

Simple path of the cursor (See FIG. 2)—The starting cursor position (“start point”) and the final position (“final point”) are used to calculate a straight line equation, derived from the simple function (y=mx+b), representing the path of the cursor from the start point to the final position. Using the calculated equation, a future path is interpolated/predicted from the final point out to the computer display's borders or to a specified length. The virtual cursor(s) is positioned at specific points, intended cursor destinations, in areas relevant to the future path from the final cursor position of the actual cursor to the end of the interpolated future path.

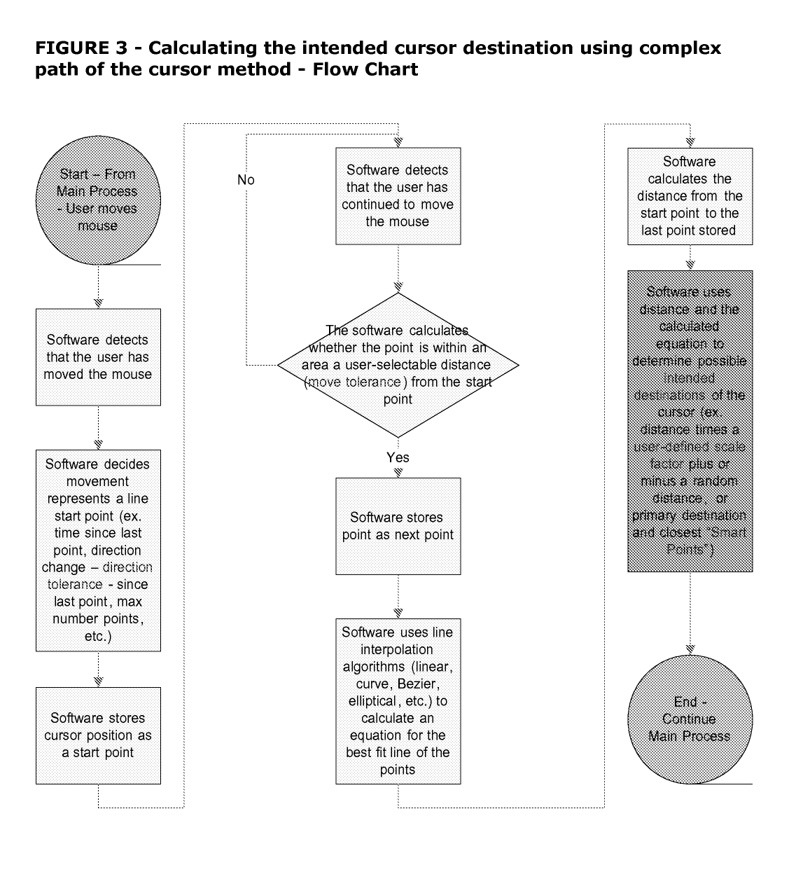

Complex path of the cursor (See FIG. 3)—The starting cursor position plus all points to the final position are stored in an storage area. The stored points are then analyzed using on of several methods (best fit, linear best-fit, curve best-fit, elliptical best-fit/interpolation, Bezier interpolation, etc.) and a equation representing the path of the pointer from the start point through the points to the final position is calculated. Using the calculated equation, a future path is interpolated/predicted from the final point out to the computer display's borders or to a specified length. The virtual cursor(s) is positioned at specific points, intended cursor destinations, in areas relevant to the future path from the final cursor position to the end of the interpolated future path.

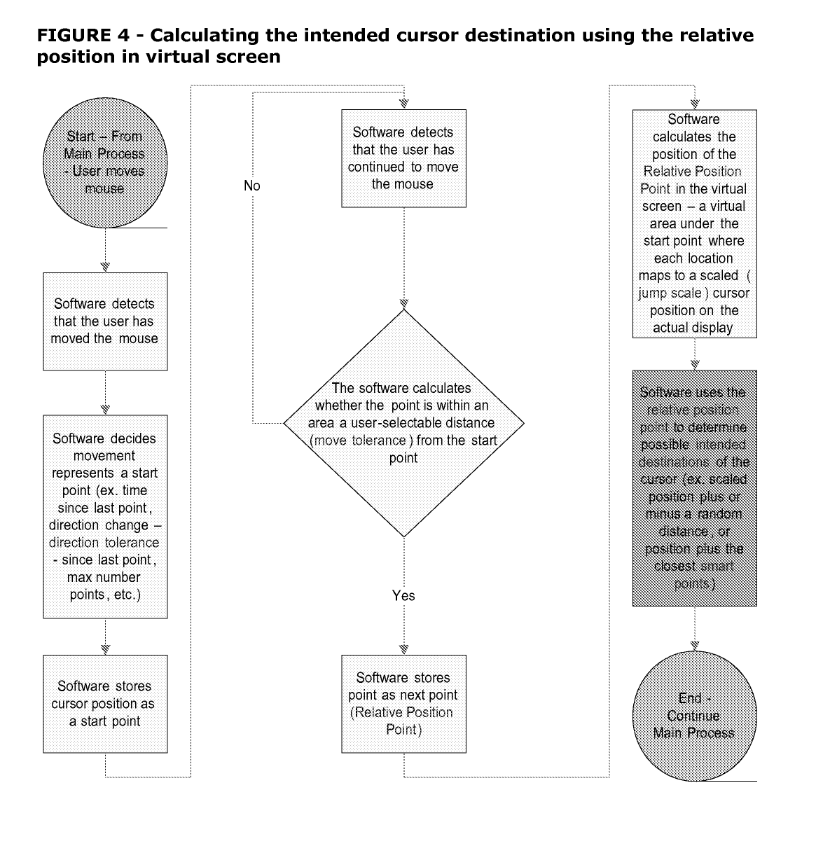

Relative position in a virtual screen area (See FIG. 4)—The relative position of the cursor in a mini virtual screen is mapped to the actual screen—optionally, mini virtual screen is displayed behind the stopped cursor. The virtual screen is a rectangle with dimensions scaled from the display device's selected resolution. Subsequent motions of the cursor within the virtual screen are converted to intended cursor destinations on the computer display. The virtual cursor(s) is displayed at the scaled location on the actual screen—intended cursor destination—as well as several positions nearby.

Methods 1, 2, and 3 above, combined with an analysis of the history of previous cursor actions (movements, clicks, etc.) (See Flow Chart 5)—The program stores the coordinates of previous cursor movements, final position, and cursor action (e.g. click), optionally the time (relative or absolute) the cursor action was performed, as well as the object's id, which is based characteristics and identifiers of the object (e.g. name, location, size, shape, window identity, etc.), receiving the cursor action if available. The amount of this data stored is only limited by the hardware of the machine or the user preferences. The software analyzes the previous cursor actions to determine where areas of interest may exist. For example, if multiple clicks around the point (10,10) occurred, the program can detect that there is likely at least one area of interest within an area defined by the multiple clicks. Therefore, the area is classified by the system as an area of interest. This analysis is repeated on all or part of the stored cursor history data. The result of this analysis is a map of areas of interest for the entire display and, where the object id's were stored, a map of areas of interest for each object id. Points within the areas of interest are considered intended cursors destinations, “Smart Points.” Optionally, the stored time information can be used to filter the calculated “Smart Points” for relevance to the current user actions. Combining the calculated areas of interest with the intended cursor destinations calculated in methods 1, 2, & 3, alternative virtual cursor positions can be determined. In addition to the virtual cursor(s) displayed using the methods 1, 2, & 3, other virtual cursors can be displayed at the intended cursor destinations that are within the area of interest that are closest to the calculated future path or actual screen position.

Complementing method 4, there is also the option of loading cursor action histories directly into the program. The user can load a data file into the software that contains cursor action history and object ids into the software. The software can then analyze this data and calculate areas of interest using the techniques of method 4. Alternatively, the user can load a data file into the software that contains a map of areas of interests for an object into the software. This would allow the software to bypass the analysis phases of method 4. For example, a data file would contain the areas of interests for a specific software application that would like to utilize the benefits of the software. The data file can be created, saved, and modified by the invention or by applications the complements the invention. Thus, the software would make it easier and faster for the user to move the cursor with the specific software application.

Complementing the concept in method 5, the software has features that allow its area of interests to be dynamically updated by another application. Other applications can connect with the software via interfaces that allow the inputting and manipulations of the areas of interest maps that the software has maintained for the application. This facilitates the feature in method 4 and 5. For example, a web browser can update the click map of its application windows containing a particular web page or a dynamic set of objects so that the software can more accurately determine intended cursor locations when the user is navigating within the applications windows. In other words, the software contains an interface that allows its area of interests map to be dynamically updated from other software applications.

Complementing the concept in method 4, the software can be configured so that intended cursor destinations calculated with method 4 links to a particular virtual cursor that is only positioned between calculated areas of interests.

Methods 1, 2, and 3 above, combined with an analysis of the computer display's contents for user-configurable objects, objects (icons, windows, menus, etc) that can be manipulated (clicked, dragged, highlighted, etc.) by the cursor. The program can regularly scan the operating system or receive information from the operating system to determine whether user-configurable objects are present. If the software detects that user-configurable objects are present, it stores the area defined within the boundaries of the user-configurable objects as areas of interest. Points within these areas of interest are considered intended cursors destinations, “Smart Objects.” Combining the calculated areas of interest with the future paths calculated in methods 1, 2, & 3, alternative virtual cursor positions can be determined. In addition to the virtual cursor(s) displayed using the methods 1, 2, 3 & 4, other virtual cursors can be displayed at the intended cursor destinations that are within the area of interest—Smart objects—that are closest to the calculated future path or actual cursor position.

Start point determination—the software determines a start point based on the time that has elapsed since the previous point. If the time between the previous point and the last point exceeds a threshold, then the software assumes that the last points is a start point and represents the start of a new stroke. In other words, if the cursor was idle and then was moved, the point from which the cursor is moved is the start position. Alternatively, the software can also determine the start point based on a shift in cursor direction that suggests the users intended destination has changed. For example, if the user is moving the cursor from the left side of the screen and mid-stroke moves the cursor markedly up, the point from which the cursor started moving markedly upwards could also be identified by the software as a start point.

Final point determination—the software determines the final point based on the time that has elapsed since the cursor has stopped moving, the number of points it has stored in the storage area, the distance between the current cursor position and the start point, etc.

Not-in-use determination—If the cursor stops and the virtual cursor is not selected within a certain amount of time, the virtual cursor may be removed from the screen.

Move Tolerance—If the cursor moves less than a defined minimum distance or more than defined maximum distance the program may assume that the user does not intend to use the virtual cursor.

Selecting from one of the several virtual cursors—An example procedure to select one of three displayed virtual cursors would be the user clicks the middle button to select virtual cursor 1, user scrolls the middle button up to select the virtual cursor 2, and the user scrolls the middle button down to select virtual cursor 3. Alternatively, the input device may have other non-standard buttons that can be configured to be use as alternative selection buttons.

### Materials—Screenshots and Accompanying Descriptions

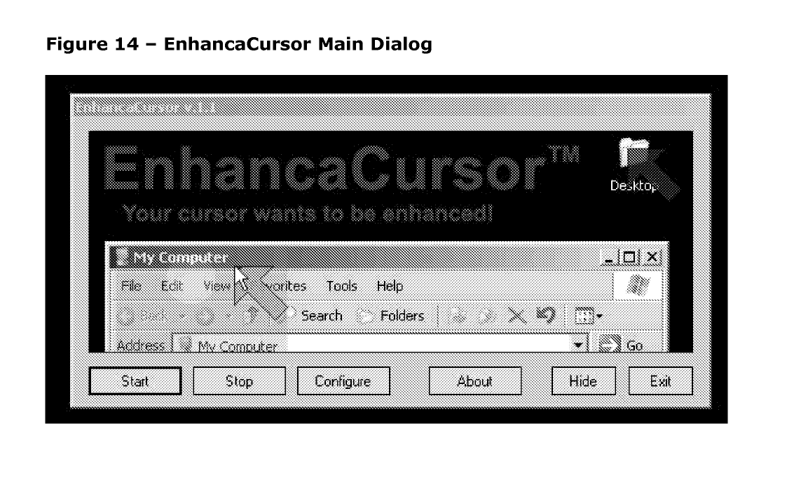

In reference now to Main Dialog FIG. 14, the main screen displays the software main logo and allows the user to access five functions of the software. The five functions are described below:

Stop—The stop button stops all software functionality but does not terminate the software.

Start—The start button resumes software functions.

Configure—The configuration shows the software configuration dialog

About—The about button displays the about dialog. The functionality of the about dialog is described below.

Hide—The hide button hides the software main dialog.

Exit—The exit button terminates the software.

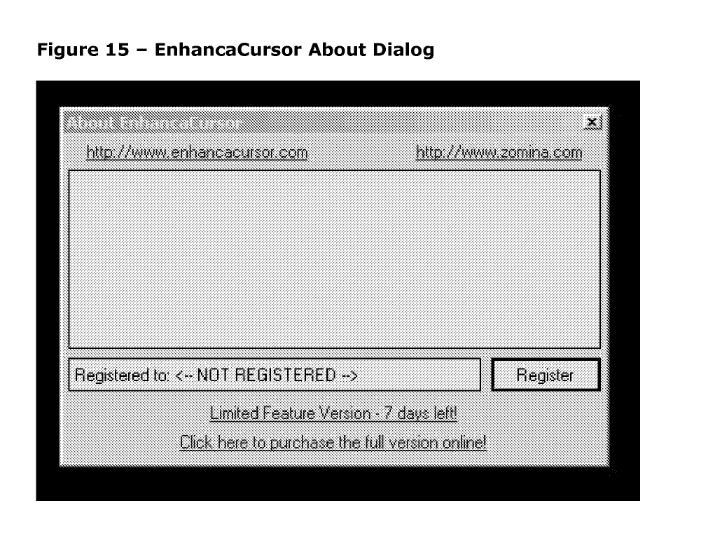

In reference to About Dialog FIG. 15, the about screen displays information about the software. This includes but is not limited to patent, copyright, and trademark information relevant to the software and the company that produces, licenses, or manufactures the related technologies. This screen also allows user to display the software's registration status, to register the software, and to activate different functionality levels related to the registration status of the software. For example, the software may have several versions with different levels of functionality. Finally, this screen includes hyperlinks to the relevant companies associated with it.

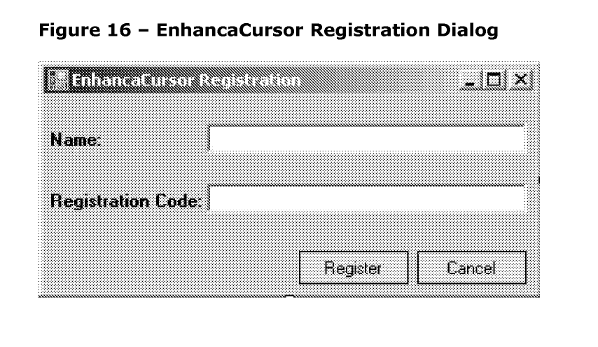

In reference to Registration Dialog FIG. 16, the registration dialog allows the user to enter registration information into the software to activate the different levels of functionality. This information can include information such as a username, unique computer identification information, a registration code, etc.

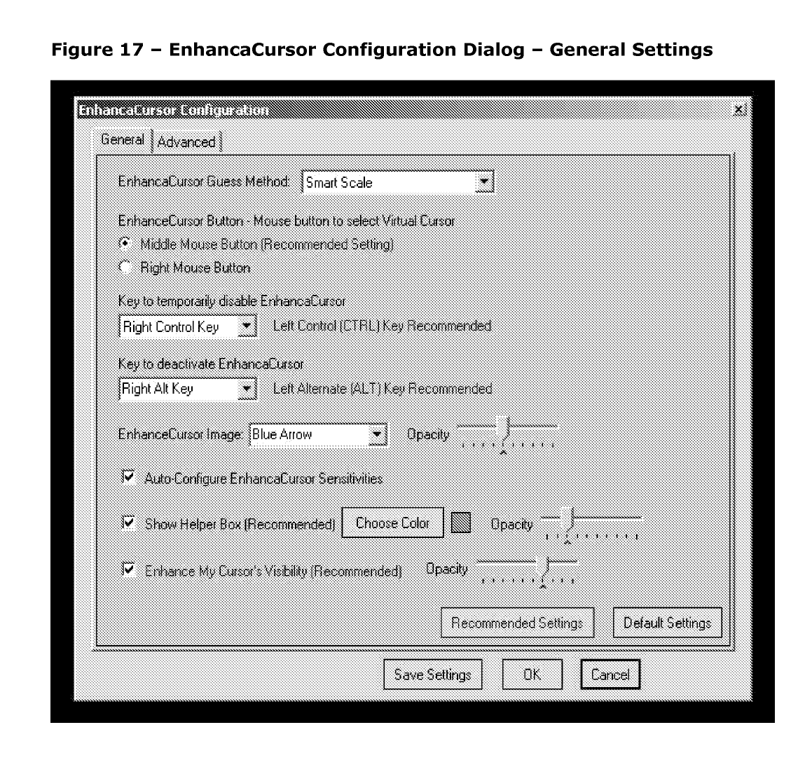

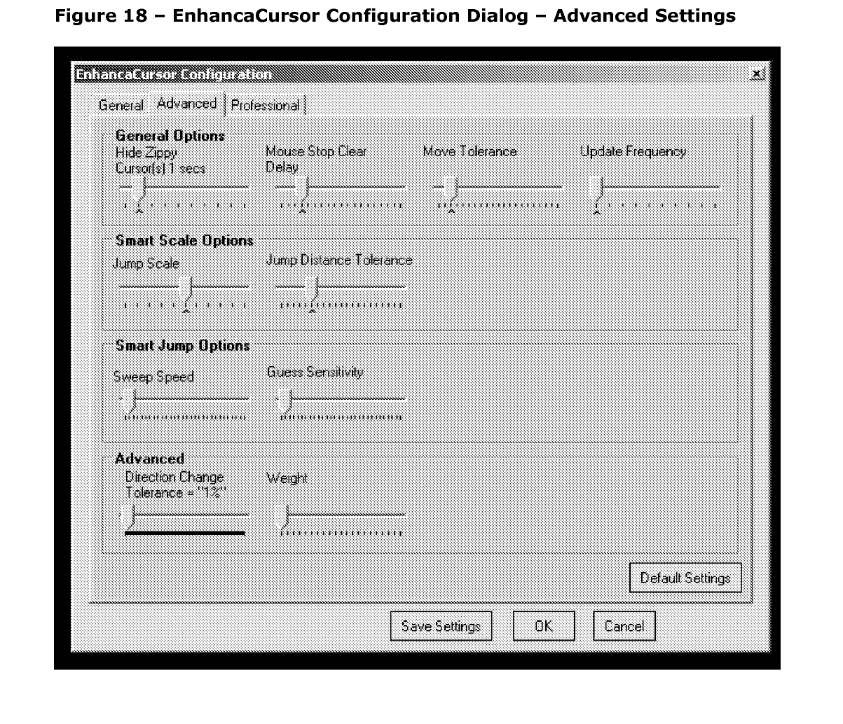

In reference to Configuration Dialog FIGS. 17, 18 , 19, the configuration dialog allows the user to customize the functionality of the software. Each of the configurable options is described in detail below:

General (FIG. 17)—

EnhancaCursor Guess Method—The user can select the method that the software will use to calculated the intended cursors destinations.

Smart Jump—This option refers to the location method above described in calculating intended cursor destinations—“Simple Path of the cursor”

Smart Scale—This option refers to the location method above described in calculating intended cursor destinations—“relative position of the cursor in a mini virtual screen and mapping it to the actual screen”

Smart Guess—This option refers to the location method above described in calculating intended cursor destinations—“Complex Path of the cursor”

Smart Guess 2—This option refers to the location method above described in calculating intended cursor destinations—“Complex Path of the cursor” using an alternative equation to determine the current and future paths.

EnhancaCursor Button—This option allows the user to select which user action activates the cursor repositioning action.

Key to Disable EnhancaCursor—By pressing this key, the user can temporarily disable software functionality. Depressing this key, re-enables software functionality.

Key to Deactivate EnhancaCursor—By pressing this key, software functionality is disabled. Functionality continues to be disabled until this key is pressed again.

EnhancaCursor Image—The user can select the design of the virtual cursor(s) from a number of pre-defined images or a custom image of their choice.

Opacity—The virtual cursors can be made more transparent or less transparent using by changing this option.

Auto-Configure EnhancaCursor Sensitivities—This option disables the auto-configure mode, where the software will automatically try and determine the best options for the user-configurable options based on the users movement, click, and usage patterns.

Show Helper Box—This option enables or disables the helper box that is shown behind the cursor upon initial mouse movement and software intended cursor destination determining activities. If enabled, the helper box automatically is disabled after a pre-determined time to enhance learning. This automatic disabling can be deactivated by the user.

Choose Color—The user can select the color of the helper box using this option.

Choose Opacity—The helper box can be made more transparent or less transparent by changing this option.

Enhance My Cursor—This option enables a function to enhance the visibility of the users default cursor.

Opacity—The cursor enhancement can be made more transparent or less transparent by changing this option.

Recommended Settings—This option changes all the user-options to recommended setting built into the software.

Default Settings—This option changes all the user-options to default setting built into the software.

Save Settings—This button saves all the user settings.

OK—This button closes the configuration dialog box and prompts the user to save settings.

Cancel—This button closes the configuration dialog box without saving any changes to the settings.

Advanced (FIG. 18)—

General Options

Hide Virtual Cursor Delay—This option adjust the amount of time the software waits after cursor movement has stopped before hiding the virtual cursors.

Mouse Stop Clear Delay—This option adjust the amount of time the software waits before deciding that the next movement represents the start of a new calculation cycle. In other words, this adjusts the amount of time the software waits before deciding that the next cursor movement represent the start of a new movement path.

Move Tolerance—This option adjust the distance the cursor must be moved from the start point before the software begins to guess the intended cursor destination(s).

Smart Scale Options—These options are specific to the “relative position in the virtual screen” intended cursor destination determination function

Jump Scale—This option changes the size of the region that the software scales the virtual screen relative to the resolution of the actual screen. Therefore, this function changes to mapping of the virtual cursors on the screen. A larger jump scale value makes the virtual cursors move slower. A smaller jump scale value makes the virtual cursors move faster.

Jump Distance Tolerance—This option changes the distance outside of the virtual screen that the software continues to respond to cursor movements.

Smart Jump Options—These options are specific to the “complex and simple path of the cursor” intended cursor destination determination functions

Sweep Speed—This option changes the scale of the distance that the virtual cursor moves relative to the distance that the actual cursor has moved from the start point. The larger the scale the faster the virtual cursors move away from the start point. The smaller the scale the slower the virtual cursors move away from the start point.

Guess Sensitivity—If smart points is disabled, this option changes the range of the random values used to determine the location of the non-primary virtual cursors. If smart points is enabled, this option changes the distance value being used to determine the range of additional target areas that the software may consider for the non-primary virtual cursors. For example, a larger guess sensitivity value, would allow the software to select target areas farther from the calculated intended destination as additional intended destination. A smaller guess sensitivity value would allow the software to select areas of interest close to the calculated intended destination as additional intended destinations.

Advanced

Direction Change Tolerance—This option changes the sensitivity of the software to cursor direction changes that would signify the start of a new intended destination calculation cycle.

Weight—This option changes the number of points that are used to determine the best-fit line when the complex direction function is used to calculate the intended cursor destinations.

Default Settings—This option changes all the user-options to default setting built into the software.

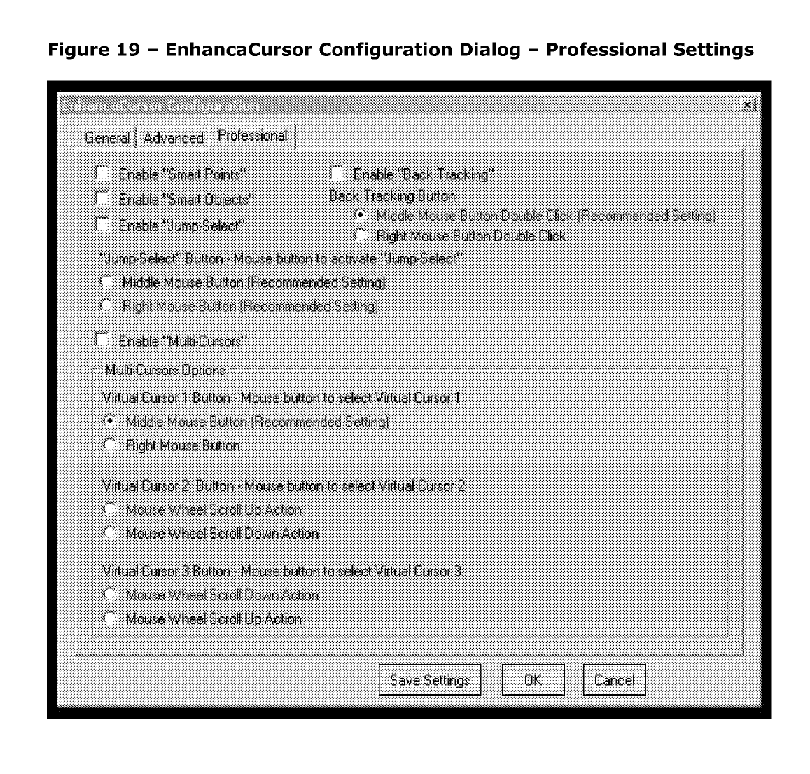

Professional (FIG. 19)—

Enable—“Smart Points”—This option enables the function of intended cursor destination determination combined with an analysis of the history of previous clicks to increase the accuracy of the non-primary virtual cursors.

Enable—“Smart Objects”—This option enables the function of intended cursor destination determination combined with an analysis of user-configurable objects on the computer display to increase the accuracy of the non-primary virtual cursors.

Enable—“Jump-Select”—This option changes whether the user would like the software to simulate a click action after repositioning the cursor to the position of the selected virtual cursor.

Enable—“Back-Tracking”—This option changes whether the user would like the software to display a virtual cursor at the previous position of the cursor prior to a jump and allows the user to select that virtual cursor as the intended cursor destination via a user input action.

[symbol] Back-Tracking” Button—This option allows the user to select which user action activates the “Back-Tracking” feature of the software.

Enable—“Multi-Cursors”—This option changes whether the user would like the software to display several non-primary virtual cursors in additional to the primary virtual cursor. The primary cursor shows the intended cursor destination as calculated by the software.

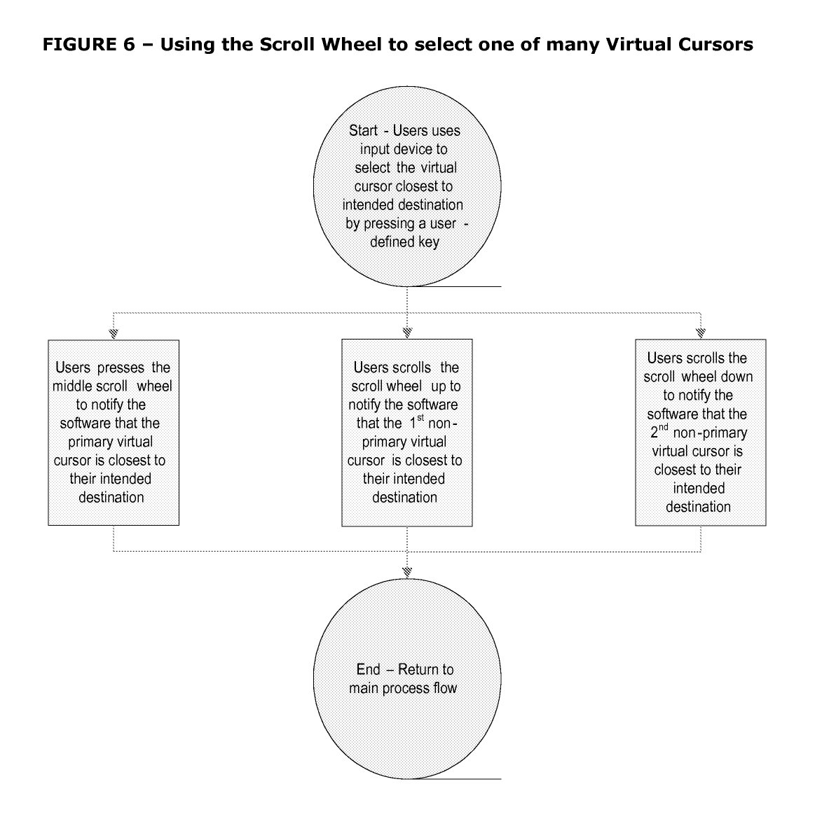

Multi-Cursor Options—These option determine which user action will activate the Jump and Jump-Select functions of the software—see FIG. 6 for more details.

Virtual Cursor 1 Button—the user can select a combination of user inputs that will inform the software that the 1^{st} virtual cursor is the virtual cursor nearest their intended destination

Virtual Cursor 2 Button—the user can select a combination of user inputs that will inform the software that the 2^{nd} virtual cursor is the virtual cursor nearest their intended destination

Virtual Cursor 3 Button—the user can select a combination of user inputs that will inform the software that the 3^{rd} virtual cursor is the virtual cursor nearest their intended destination

Additional Cursors and buttons may apply.

### Methods—Software Process Flowcharts (Main Process & Location Determination Methods)

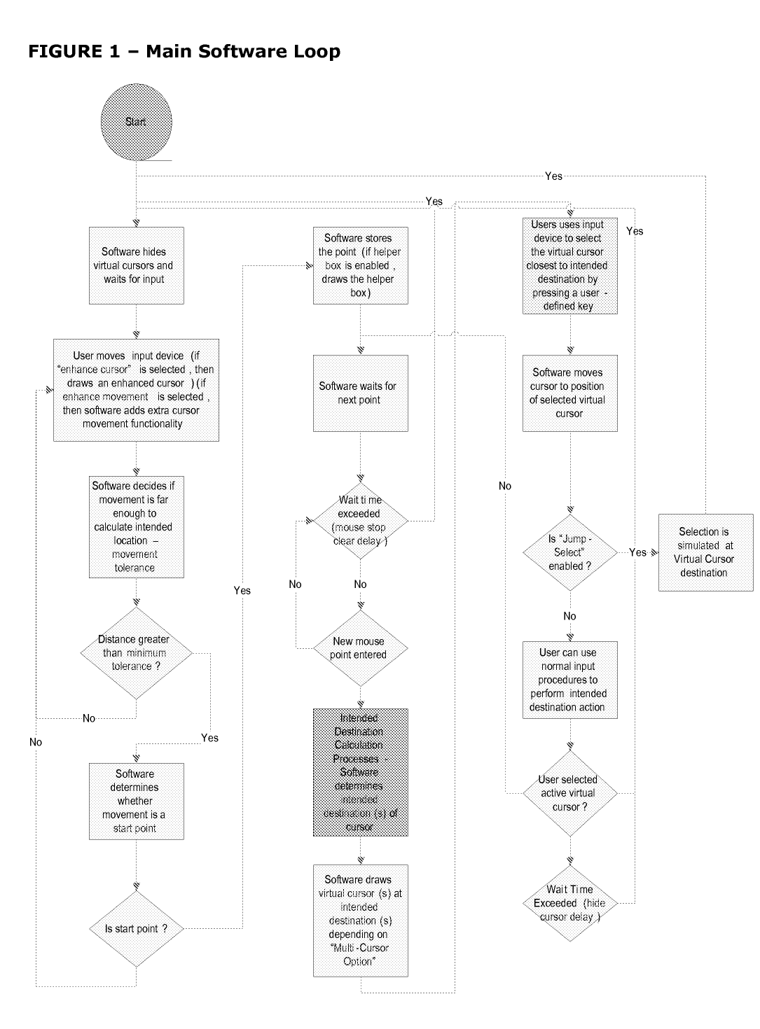

FIG. 1—Flow Chart, Main Software Loop

FIG. 2—Flow Chart, Calculating the intended cursor destination using Simple Path Method

FIG. 3—Flow Chart, Calculating the intended cursor destination using Complex Path Method

FIG. 4—Flow Chart, Calculating the intended cursor destination using the relative position in virtual screen

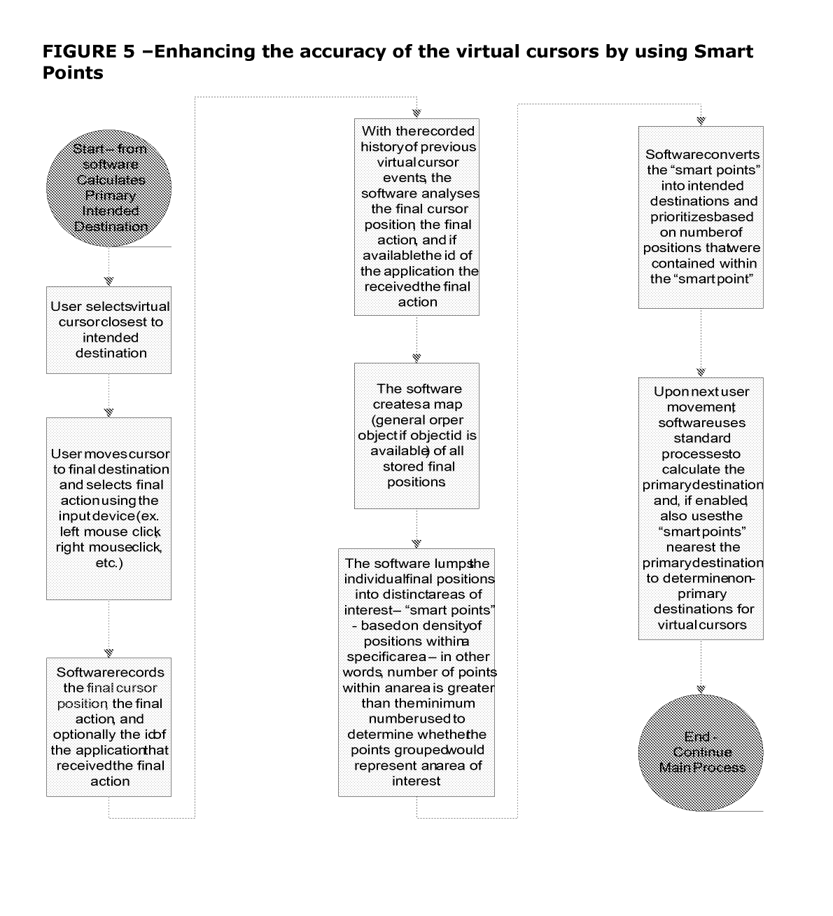

FIG. 5—Flow Chart, Enhancing the accuracy of the virtual cursors by using areas of interest and “Smart Points”

FIG. 6—Flow Chart, Using the Scroll Wheel to select one of many Virtual Cursors

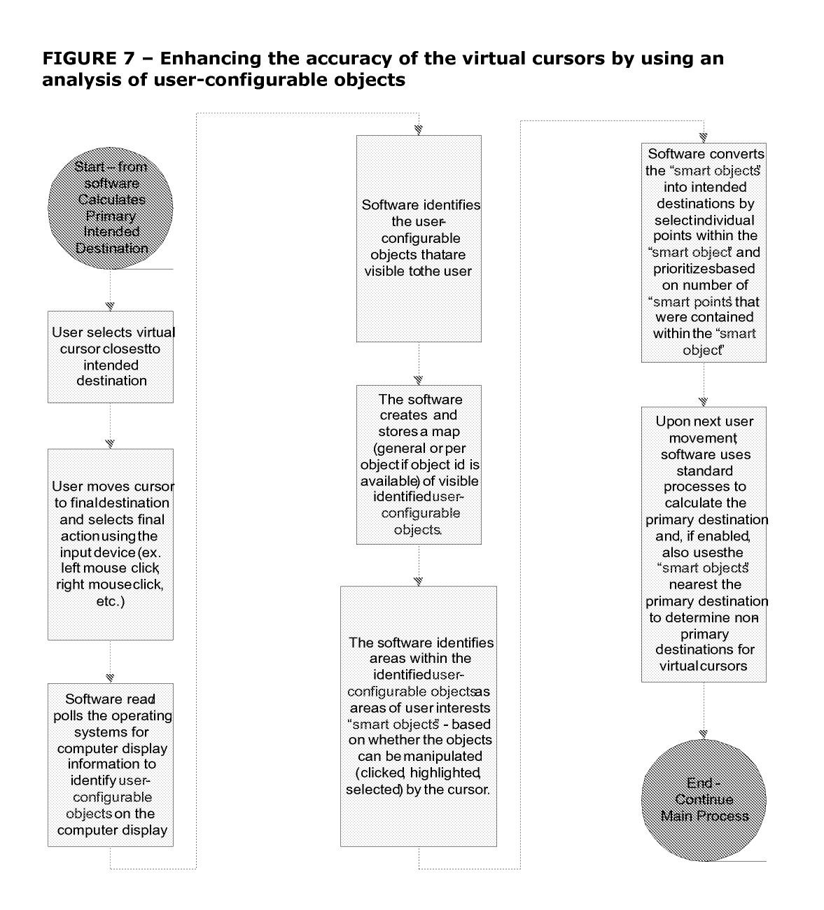

FIG. 7—Flow Chart, Enhancing the accuracy of the virtual cursors by using an analysis of user-configurable objects.

### EXAMPLES

### Example 1

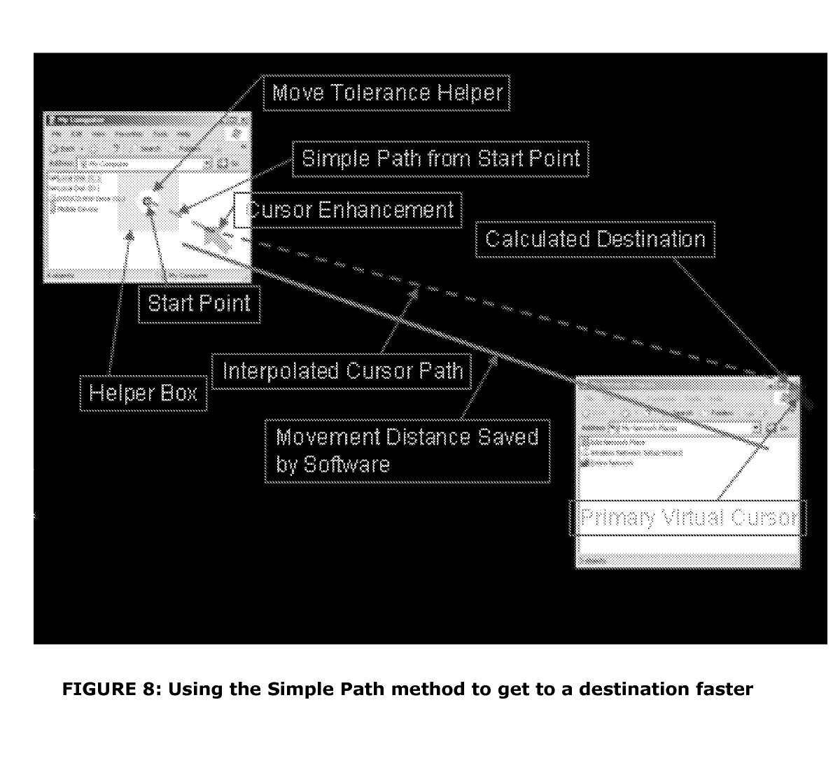

Referring now to FIG. 8, which shows using the Simple Path method to get to a destination faster—In this example, the user is trying to get to a point on the far-right side of the screen relative to the position of the actual cursor—start point. Because the user has enabled the enhance cursor feature, the software has highlighted the cursor with a green cursor enhancement arrow. After the user moves the cursor from the start point, the software displays a helper box (general area that the software is actively calculating the intended cursor destination) and calculates the path and distance using a simple path method described above. After the user has moved the cursor outside of the minimum move distance (visible within the helper box ), the software displays the virtual cursor at the calculated intended cursor destination. The user can then use the selected software activation input to quickly reposition the actual cursor at the intended cursor destination that the software has calculated. This saves the user significant time and movement.

### Example 2

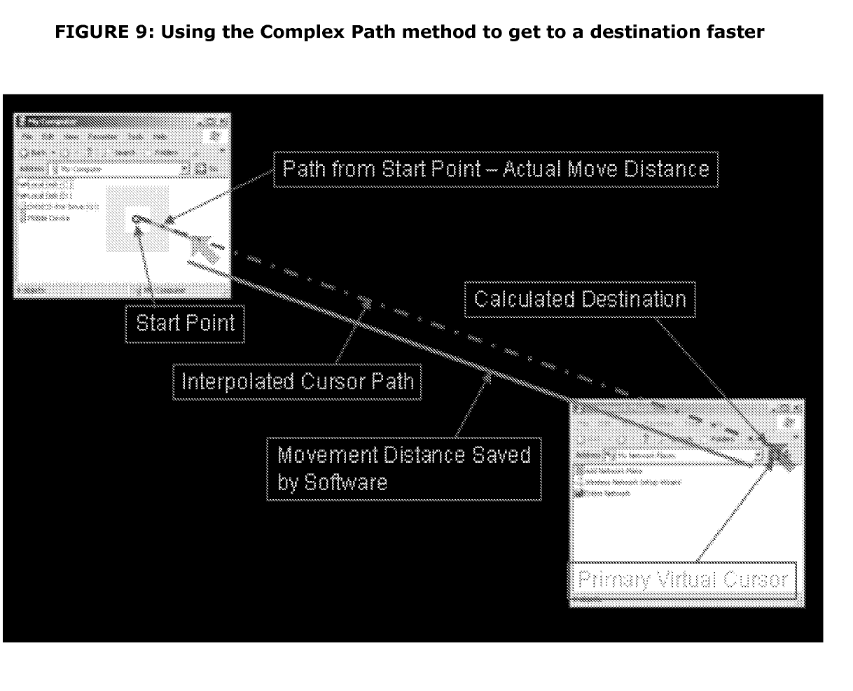

Referring now to FIG. 9, which shows using the Complex Path method to get to a destination faster—This example is similar to Example 1 except the diagram has been updated to reflect the complex direction and distance calculation processes of the software. In addition to the enhanced cursor, helper window, and virtual cursor, an example path that the software has interpolated is highlighted.

### Example 3

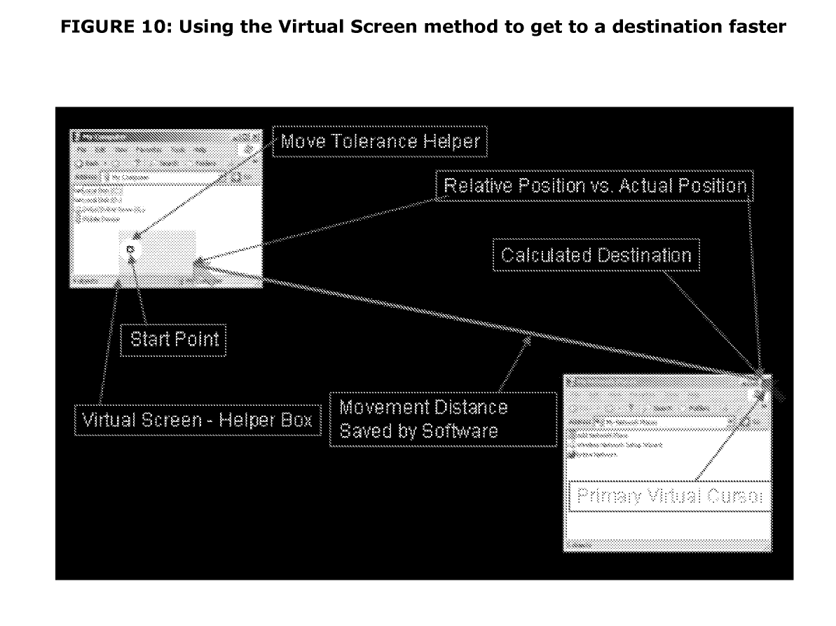

Referring now to FIG. 10, which shows using the Virtual Screen method to get to a destination faster—This example is similar to example 1 except the diagram has been updated to reflect the virtual screen method calculation process of the software. It highlights the differences in the function of the helper box, specifically how it maps a relative position in the virtual screen to an actual position on the actual display.

### Example 4

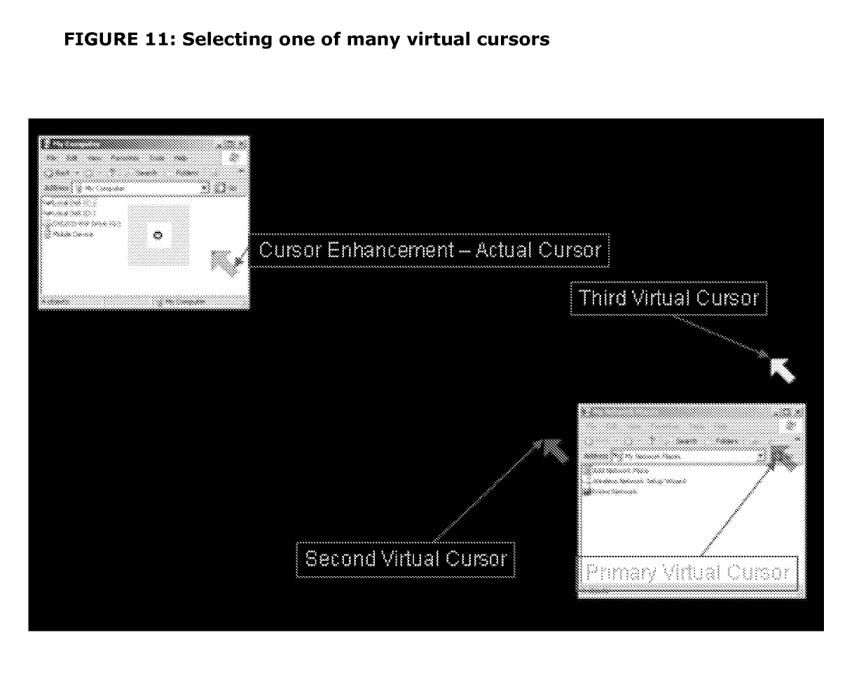

Referring now to FIG. 11, which shows selecting one of many virtual cursors—This use case highlights the capability of the software to calculate several intended destinations and to display several virtual cursors at the calculated intended destinations. The user can select the virtual cursor closest to their actual intended location using a user-determined input action or the middle scroll wheel method described in the previous sections—FIG. 6.

### Example 5

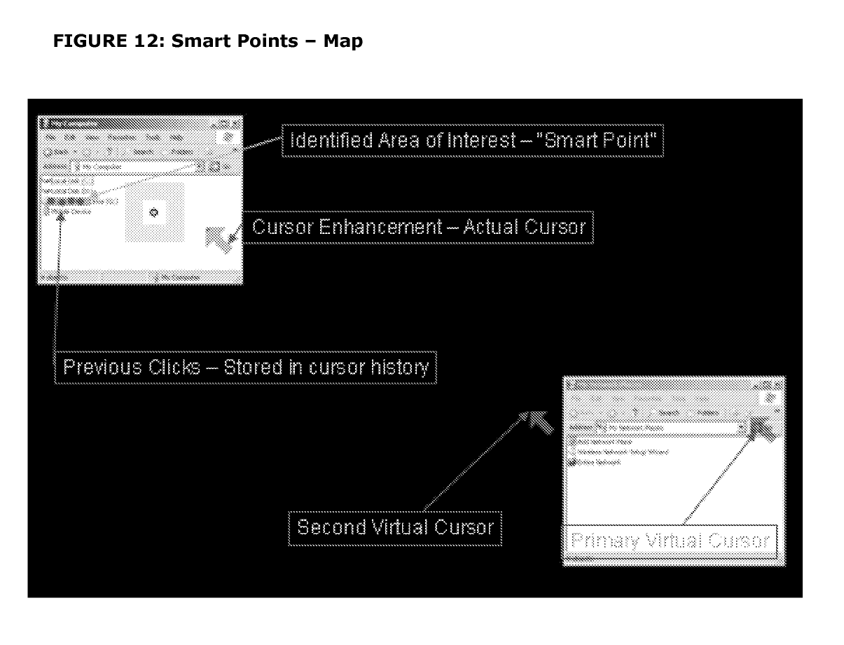

Referring now to FIG. 12 which shows Smart Points Map—This example highlights the capability of the software to calculate an area of interest—“Smart Points”—based on previous cursor positions, the user action selected at the previous cursor positions, and the id's of the area where the action took place. The red dots show cursor positions that the user previously clicked the left mouse button. The green area highlights an area that the software has identified as an area of interest—“smart point”—based on the previous red dot cursor positions.

### Example 6

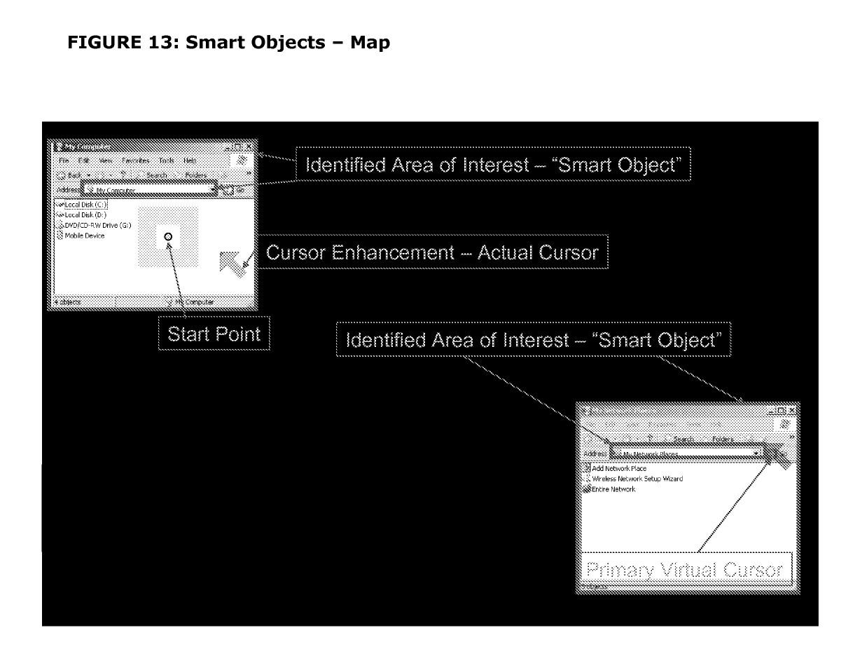

Referring now to FIG. 13 which shows a Smart Objects Map—This example highlights the capability of the software to calculate an area of interest—“Smart Object”—based on the user-configurable objects that are present on the computer display. The red boxes show areas on the screen that the software has identified as an area of interest—“Smart Object”—because they are currently visible and their properties allow them to be manipulated in some way (click, selected, highlighted, etc.) by the user.

It is understood that even though various embodiments and advantages of the present invention have been set forth in the foregoing description, the above disclosure is illustrative only, and changes may be made in detail, yet remain within the broad principles of the invention. Therefore, the present invention is to be limited only by the appended claims and their equivalents.

Furthermore, while the present invention has been described in conjunction with certain preferred embodiments, many alternatives, permutations, modifications, or variations will be apparent to those skilled in the art of computers, without departing from the spirit and scope of the invention as set forth in the appended claims or their equivalents.

What is claimed is:

1. A method of improving cursor function in a computing environment, which comprises: performing in the computing environment a method selected from the group consisting of: a) drawing a virtual screen on a computer display, b) storing cursor action history and calculating areas of user interest based on the stored cursor action history, c) displaying a virtual cursor on a computer display, d) inputting cursor action history from a source outside the computing environment and calculating areas of user interest based on the inputted cursor action history, e) identifying user-configurable objects of interest on a computer display, f) storing cursor action history, and g) inputting intended cursor destinations from a source outside the computing environment and calculating areas of user interest based on the inputted intended cursor destinations.

2. Computer readable media containing programming code for carrying out a method of improving cursor function in a computing environment, which comprises: performing in the computing environment a method selected from the group consisting of: a) drawing a virtual screen on a computer display, b) storing cursor action history and calculating areas of user interest based on the stored cursor action history, c) displaying a virtual cursor on a computer display, d) inputting cursor action history from a source other than a computer coupled pointing device and calculating areas of user interest based on the inputted cursor action history, e) identifying user-configurable objects of interest on a computer display, f) storing cursor action history, and g) inputting intended cursor destinations from a source other than a computer coupled pointing device and calculating areas of user interest based on the inputted intended cursor destinations.

3. A system for improving cursor function in a computing environment, which comprises: means for performing in the computing environment a method selected from the group consisting of: a) drawing a virtual screen on a computer display, b) storing cursor action history and calculating areas of user interest based on the stored cursor action history, c) displaying a virtual cursor on a computer display, d) inputting cursor action history from a source other than a computer coupled pointing device and calculating areas of user interest based on the inputted cursor action history, e) identifying user-configurable objects of interest on a computer display, f) storing cursor action history, and g) inputting intended cursor destinations from a source other than a computer coupled pointing device and calculating areas of user interest based on the inputted intended cursor destinations.

4. The method of claim 1, wherein the method of drawing a virtual screen on a computer display, comprises the steps of:
determining movement of a cursor on a computer display coupled to a computer in accordance with manipulations of a pointing device, including recognizing a start cursor position on the screen, a current cursor position on the screen, and a stop cursor position on the screen;
drawing a virtual screen, a visible area on the computer display that maps to positions on the computer display, behind the start cursor position, current cursor position, stop cursor position, or at a user- defined position.

5. The method of claim 1, wherein the method of interpolating the future cursor path on a computer display, comprises the steps of:
determining movement of a cursor on a computer display coupled to a computer in accordance with manipulations of a pointing device, including recognizing a start cursor position on the screen and a final cursor position on the computer display;
storing the start cursor position and the final cursor position on a computer display in a storage area;
calculating a path representing the movement of a cursor on a computer display from the start cursor position to the final cursor position;
interpolating the future path of the cursor from the current position based on the calculated path representing the movement of a cursor on a computer display from the start cursor point to the final cursor position;
identifying one or more points relative to the interpolated future cursor path as an intended cursor destination;
defining for each identified, calculated, or selected intended cursor destination a user input action (key press, mouse click, button press, etc.) that when performed indicates the user has determined that the point indicated by the intended cursor destination is closest to the users actual intended cursor destination or is the users intended cursor destination;
detecting the user input action (key press, mouse click, button press, etc.) that indicates the computer user wants to move the cursor to the position of a identified, calculated, or selected intended cursor destination; and,
moving the cursor to the intended cursor destination.

6. The method of claim 1, wherein the method of storing cursor action history and calculating areas of user interest based on the stored cursor action history, comprises the steps of:
determining movement of a cursor on a computer display coupled to a computer in accordance with manipulations of a pointing device, including recognizing a start cursor position on the screen, a current cursor position, and a final cursor position on the computer display, determining a user input action, identifying manipulations of an user input device at the final cursor position (including identifying button presses, key presses, wheel scrolls, etc.), time (absolute or relative) the action was performed, and, if available, identifying information for the object to which the cursor action was intended;
storing the cursor action history, the final cursor position on a computer display, the corresponding user input actions, the time (absolute or relative) that the cursor action was performed, and the identifying information for the object which the cursor action was intended and;
calculating areas of user interest, confined areas on the screen that contain more than a definable number of stored final cursor positions with corresponding user iput actions, based on the stored cursor action history; and,
selecting one or more points within the calculated area of user interest as an intended cursor destination.

7. The method of claim 1, wherein the method of displaying a virtual cursor on a computer display, comprises the steps of:
determining movement of a cursor on a computer display coupled to a computer in accordance with manipulations of a pointing device, including recognizing movement, position, and actions of the cursor;
displaying “virtual cursors”, one or more images indicative of a point on the screen or highlighting an existing object in a way that makes indicative of a point, on a computer display in addition to the cursor(s) on a computer display coupled to a computer manipulated in accordance with manipulations of a pointing device.

8. The method of claim 7 further comprises the steps of:
drawing a virtual cursor(s) on a computer display at a calculated, identified, or selected intended cursor destination(s); and,
repeating one or more user input actions (e.g. mouse clicks, key presses, button presses, etc.) at the position of the virtual cursor.

9. The method of claim 1, wherein the method of inputting cursor action history into the invention from a source other than a computer coupled pointing device and calculating areas of user interest based on the inputted cursor action history, comprises the steps of:
inputting cursor action history into the invention from a source other than a computer coupled pointing device;
storing the inputted cursor action history;
calculating areas of user interest, confined areas on the screen that contain more than a definable number of stored final cursor positions with corresponding user input actions, based on the inputted and stored cursor action history; and,
selecting one or more points within the calculated area of user interest as an intended cursor destination.

10. The method of claim 1, wherein the method of identifying user-configurable objects as areas of interest on a computer display, comprises the steps of:
polling for or receiving from the operating system of the computer, data that the software can use to identify visible user-configurable objects, objects that can be manipulated (clicked, dragged, highlighted, etc.) by the cursor that are visible on the computer display;
identifying user-configurable objects from the data, including the object boundaries and how the object can be manipulated;
identifying the area defined within the boundaries of the identified user-configurable objects as an area of user interest; and,
identifying one or more points within the calculated area of user interest as an intended cursor destination.

11. The method of claim 1, wherein the method of storing cursor action history, comprises the steps of;
determining movement of a cursor on a computer display coupled to a computer in accordance with manipulations of a pointing device, including recognizing a start cursor position on the screen, a current cursor position, and a final cursor position on the computer display;
determining a cursor action, manipulations of an user input device at the final cursor position (including identifying button and key presses, wheel scrolls, etc.), time (absolute or relative) the action was performed, and, if available, identifying information for the object to which the cursor action was intended;
storing the cursor action history, the final cursor position on a computer display, the corresponding user input action(s), the time (absolute or relative) that the cursor action was performed, and the identifying information for the object which the user input action(s) was intended;
identifying as an intended cursor destination the final cursor position where a cursor action was performed; and,
storing the identified intended cursor destinations for later reloading.

12. The method of claim 1, wherein the method of inputting intended cursor destinations and cursor action history into the invention from a source other than a computer coupled pointing device, comprises the steps of:
inputting intended cursor destinations into the invention from a source other than a computer coupled pointing device;
inputting cursor action history into the invention from a source other than a computer coupled pointing device; and,
storing the inputted intended cursor destination with the accompanying inputted cursor action history.

13. The computer readable media containing programming code of claim 2, wherein the method of drawing a virtual screen on a computer display, comprises the steps of:
determining movement of a cursor on a computer display coupled to a computer in accordance with manipulations of a pointing device, including recognizing a start cursor position on the screen, a current cursor position on the screen, and a stop cursor position on the screen;
drawing a virtual screen, a visible area on the computer display that maps to positions on the computer display, behind the start cursor position, current cursor position, stop cursor position, or at a user- defined position.

14. The computer readable media containing programming code of claim 2, wherein the method of interpolating the future cursor path on a computer display, comprises the steps of:
determining movement of a cursor on a computer display coupled to a computer in accordance with manipulations of a pointing device, including recognizing a start cursor position on the screen and a final cursor position on the computer display;
storing the start cursor position and the final cursor position on a computer display in a storage area;
calculating a path representing the movement of a cursor on a computer display from the start cursor position to the final cursor position;
interpolating the future path of the cursor from the current position based on the calculated path representing the movement of a cursor on a computer display from the start cursor point to the final cursor position;
identifying one or more points relative to the interpolated future cursor path as an intended cursor destination;
defining for each identified, calculated, or selected intended cursor destination a user input action (key press, mouse click, button press, etc.) that when performed indicates the user has determined that the point indicated by the intended cursor destination is closest to the users actual intended cursor destination or is the users intended cursor destination;
detecting the user input action (key press, mouse click, button press, etc.) that indicates the computer user wants to move the cursor to the position of a identified, calculated, or selected intended cursor destination; and,
moving the cursor to the intended cursor destination.

15. The computer readable media containing programming code of claim 2, wherein the method of storing cursor action history and calculating areas of user interest based on the stored cursor action history, comprises the steps of:
determining movement of a cursor on a computer display coupled to a computer in accordance with manipulations of a pointing device, including recognizing a start cursor position on the screen, a current cursor position, and a final cursor position on the computer display, determining a user input action, identifying manipulations of an user input device at the final cursor position (including identifying button presses, key presses, wheel scrolls, etc.), time (absolute or relative) the action was performed, and, if available, identifying information for the object to which the cursor action was intended;
storing the cursor action history, the final cursor position on a computer display, the corresponding user input actions, the time (absolute or relative) that the cursor action was performed, and the identifying information for the object which the cursor action was intended and;
calculating areas of user interest, confined areas on the screen that contain more than a definable number of stored final cursor positions with corresponding user iput actions, based on the stored cursor action history; and,
selecting one or more points within the calculated area of user interest as an intended cursor destination.

16. The computer readable media containing programming code of claim 2, wherein the method of displaying a virtual cursor on a computer display, comprises the steps of:
determining movement of a cursor on a computer display coupled to a computer in accordance with manipulations of a pointing device, including recognizing movement, position, and actions of the cursor;
displaying “virtual cursors”, one or more images indicative of a point on the screen or highlighting an existing object in a way that makes indicative of a point, on a computer display in addition to the cursor(s) on a computer display coupled to a computer manipulated in accordance with manipulations of a pointing device.

17. The The computer readable media containing programming code of claim 7 further comprises the steps of:
drawing a virtual cursor(s) on a computer display at a calculated, identified, or selected intended cursor destination(s); and,
repeating one or more user input actions (e.g. mouse clicks, key presses, button presses, etc.) at the position of the virtual cursor.

18. The computer readable media containing programming code of claim 2, wherein the method of inputting cursor action history into the invention from a source other than a computer coupled pointing device and calculating areas of user interest based on the inputted cursor action history, comprises the steps of:
inputting cursor action history into the invention from a source other than a computer coupled pointing device;
storing the inputted cursor action history;
calculating areas of user interest, confined areas on the screen that contain more than a definable number of stored final cursor positions with corresponding user input actions, based on the inputted and stored cursor action history; and,
selecting one or more points within the calculated area of user interest as an intended cursor destination.

19. The computer readable media containing programming code of claim 2, wherein the method of identifying user-configurable objects as areas of interest on a computer display, comprises the steps of:
polling for or receiving from the operating system of the computer, data that the software can use to identify visible user-configurable objects, objects that can be manipulated (clicked, dragged, highlighted, etc.) by the cursor that are visible on the computer display;
identifying user-configurable objects from the data, including the object boundaries and how the object can be manipulated;
identifying the area defined within the boundaries of the identified user-configurable objects as an area of user interest; and,
identifying one or more points within the calculated area of user interest as an intended cursor destination.

20. The computer readable media containing programming code of claim 2, wherein the method of storing cursor action history, comprises the steps of;
determining movement of a cursor on a computer display coupled to a computer in accordance with manipulations of a pointing device, including recognizing a start cursor position on the screen, a current cursor position, and a final cursor position on the computer display;
determining a cursor action, manipulations of an user input device at the final cursor position (including identifying button and key presses, wheel scrolls, etc.), time (absolute or relative) the action was performed, and, if available, identifying information for the object to which the cursor action was intended;
storing the cursor action history, the final cursor position on a computer display, the corresponding user input action(s), the time (absolute or relative) that the cursor action was performed, and the identifying information for the object which the user input action(s) was intended;
identifying as an intended cursor destination the final cursor position where a cursor action was performed; and,
storing the identified intended cursor destinations for later reloading.

21. The computer readable media containing programming code of claim 2, wherein the method of inputting intended cursor destinations and cursor action history into the invention from a source other than a computer coupled pointing device, comprises the steps of:
inputting intended cursor destinations into the invention from a source other than a computer coupled pointing device;
inputting cursor action history into the invention from a source other than a computer coupled pointing device; and,
storing the inputted intended cursor destination with the accompanying inputted cursor action history.

22. The system for improving cursor function in a computing environment of claim 3, wherein the means for performing comprises means for drawing a virtual screen on a computer display, which comprises the steps of:
determining movement of a cursor on a computer display coupled to a computer in accordance with manipulations of a pointing device, including recognizing a start cursor position on the screen, a current cursor position on the screen, and a stop cursor position on the screen;
drawing a virtual screen, a visible area on the computer display that maps to positions on the computer display, behind the start cursor position, current cursor position, stop cursor position, or at a user-defined position.

23. The system for improving cursor function in a computing environment of claim 3, wherein the means for performing comprises means for interpolating the future cursor path on a computer display, comprises the steps of:
determining movement of a cursor on a computer display coupled to a computer in accordance with manipulations of a pointing device, including recognizing a start cursor position on the screen and a final cursor position on the computer display;
storing the start cursor position and the final cursor position on a computer display in a storage area;
calculating a path representing the movement of a cursor on a computer display from the start cursor position to the final cursor position;
interpolating the future path of the cursor from the current position based on the calculated path representing the movement of a cursor on a computer display from the start cursor point to the final cursor position;
identifying one or more points relative to the interpolated future cursor path as an intended cursor destination;
defining for each identified, calculated, or selected intended cursor destination a user input action (key press, mouse click, button press, etc.) that when performed indicates the user has determined that the point indicated by the intended cursor destination is closest to the users actual intended cursor destination or is the users intended cursor destination;
detecting the user input action (key press, mouse click, button press, etc.) that indicates the computer user wants to move the cursor to the position of a identified, calculated, or selected intended cursor destination; and,
moving the cursor to the intended cursor destination.

24. The system for improving cursor function in a computing environment of claim 3, wherein the means for performing comprises means for storing cursor action history and calculating areas of user interest based on the stored cursor action history, comprises the steps of:
determining movement of a cursor on a computer display coupled to a computer in accordance with manipulations of a pointing device, including recognizing a start cursor position on the screen, a current cursor position, and a final cursor position on the computer display, determining a user input action, identifying manipulations of an user input device at the final cursor position (including identifying button presses, key presses, wheel scrolls, etc.), time (absolute or relative) the action was performed, and, if available, identifying information for the object to which the cursor action was intended;
storing the cursor action history, the final cursor position on a computer display, the corresponding user input actions, the time (absolute or relative) that the cursor action was performed, and the identifying information for the object which the cursor action was intended and;
calculating areas of user interest, confined areas on the screen that contain more than a definable number of stored final cursor positions with corresponding user input actions, based on the stored cursor action history; and,
selecting one or more points within the calculated area of user interest as an intended cursor destination.

25. The system for improving cursor function in a computing environment of claim 3, wherein the means for performing comprises means for displaying a virtual cursor on a computer display, comprises the steps of:
determining movement of a cursor on a computer display coupled to a computer in accordance with manipulations of a pointing device, including recognizing movement, position, and actions of the cursor;
displaying “virtual cursors”, one or more images indicative of a point on the screen or highlighting an existing object in a way that makes indicative of a point, on a computer display in addition to the cursor(s) on a computer display coupled to a computer manipulated in accordance with manipulations of a pointing device.

26. The method of claim 25 further comprises the steps of:
drawing a virtual cursor(s) on a computer display at a calculated, identified, or selected intended cursor destination(s); and,
repeating one or more user input actions including mouse clicks, key presses, and button presses, at the position of the virtual cursor.

27. The system for improving cursor function in a computing environment of claim 3, wherein the means for performing comprises means for inputting cursor action history into the invention from a source other than a computer coupled pointing device and calculating areas of user interest based on the inputted cursor action history, comprises the steps of:
inputting cursor action history into the invention from a source other than a computer coupled pointing device;
storing the inputted cursor action history;
calculating areas of user interest, confined areas on the screen that contain more than a definable number of stored final cursor positions with corresponding user input actions, based on the inputted and stored cursor action history; and,
selecting one or more points within the calculated area of user interest as an intended cursor destination.

28. The system for improving cursor function in a computing environment of claim 3, wherein the means for performing comprises means for identifying user-configurable objects as areas of interest on a computer display, comprises the steps of:
polling for or receiving from the operating system of the computer, data that the software can use to identify visible user-configurable objects, objects that can be manipulated (clicked, dragged, highlighted, etc.) by the cursor that are visible on the computer display;
identifying user-configurable objects from the data, including the object boundaries and how the object can be manipulated;
identifying the area defined within the boundaries of the identified user-configurable objects as an area of user interest; and,
identifying one or more points within the calculated area of user interest as an intended cursor destination.

29. The system for improving cursor function in a computing environment of claim 3, wherein the means for performing comprises means for storing cursor action history, comprises the steps of;
determining movement of a cursor on a computer display coupled to a computer in accordance with manipulations of a pointing device, including recognizing a start cursor position on the screen, a current cursor position, and a final cursor position on the computer display;
determining a cursor action, manipulations of an user input device at the final cursor position (including identifying button and key presses, wheel scrolls, etc.), time (absolute or relative) the action was performed, and, if available, identifying information for the object to which the cursor action was intended;
storing the cursor action history, the final cursor position on a computer display, the corresponding user input action(s), the time (absolute or relative) that the cursor action was performed, and the identifying information for the object which the user input action(s) was intended;
identifying as an intended cursor destination the final cursor position where a cursor action was performed; and,
storing the identified intended cursor destinations for later reloading.

30. The system for improving cursor function in a computing environment of claim 3, wherein the means for performing comprises means for inputting intended cursor destinations and cursor action history into the invention from a source other than a computer coupled pointing device, comprises the steps of:
inputting intended cursor destinations into the invention from a source other than a computer coupled pointing device;
inputting cursor action history into the invention from a source other than a computer coupled pointing device; and,
storing the inputted intended cursor destination with the accompanying inputted cursor action history.
